(19) United States
(12) Patent Application Publication
(10) Pub. No.: US 2015/0323988 A1
(43) Pub. Date: Nov. 12, 2015

(54) OPERATING APPARATUS FOR AN ELECTRONIC DEVICE

(71) Applicant: AUDI AG, Ingolstadt (DE)

(72) Inventor: Marcus KUEHNE, Beilngries (DE)

(73) Assignee: AUDI AG, Ingolstadt (DE)

(21) Appl. No.: 14/704,104

(22) Filed: May 5, 2015

(30) Foreign Application Priority Data
May 8, 2014 (DE) 10 2014 006 776.9

(51) Int. Cl. G06F 3/01; G06F 3/0482; G06F 3/041; G02B 27/01; G06F 3/147

(52) U.S. Cl. CPC G06F 3/011; G02B 27/017; G06F 3/147; G06F 3/0416; G06F 3/0482; G02B 2027/0134; G02B 2027/0187

(57) ABSTRACT

An operating apparatus operates an electronic device. The operating apparatus has a display device to be worn on the head, which screens the eyes of a user from a surrounding area in an opaque manner and to depict a virtual space stereoscopically in front of the eyes. A control device displays at least one spatial element in the virtual space by the display device. A user controls a selection element in the virtual space without visual contact with the surrounding area in a manner that only negligibly impairs the user's sense of orientation. A touchpad is provided and connected to the control device. The control device is designed to position a selection symbol at a spatial position in the virtual space according to the contact point of an object on the touchpad, and thereby to select a spatial element from the at least one spatial element.

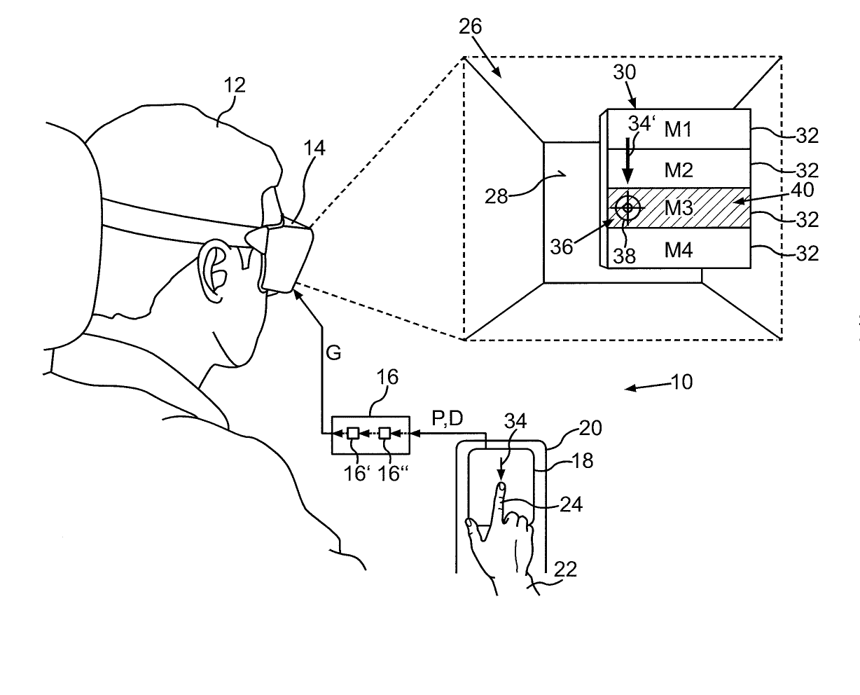

### CROSS REFERENCE TO RELATED APPLICATIONS

This application is based on and hereby claims priority to German Application No. 10 2014 006 776.9 filed on May 8, 2014, the contents of which are hereby incorporated by reference.

### BACKGROUND

The invention relates to an operating apparatus for operating an electrical device.

A user can experience the problem in virtual reality of impaired spatial orientation because of the lack of direct visual contact with stationary objects in the real surroundings. Therefore when moving the head or limbs, the user is especially dependent on precise adjustment of positions of the spatial elements in the virtual space. For instance, too severe a movement of the spatial elements in the virtual space in response to just a slight head movement or body movement can result in the user losing balance.

The interaction of the user with spatial elements in the virtual space presents a particular challenge. This interaction is needed, for instance, if the user is meant to select a menu option from a selection menu. To do this, the user must normally operate a virtual selection element such as a cursor, for example. It is known in this regard that the user holds his hand in front of him in the space, and the position of the hand is detected in order then to depict a three-dimensional representation of the hand in the virtual space. The hand position should be detected very precisely in this case, because otherwise the user cannot orientate the virtual representation of his hand sufficiently accurately with respect to the selection menu. Usually, a lack of precision in finding the position can be compensated by a particularly large depiction of the menu options, with the result that they practically fill the entire virtual space or field of vision of the user.

Detection of the head position is usually based on different detection technology from that used for detecting the hand position and controlling the menu. This can result in relative movements between the hand and the surrounding virtual space that are caused solely by different measurement errors of the two detection systems. If a large area of the field of vision of the user is now covered by spatial elements, the position of which cannot be correlated precisely with the user's head movements, this can impair the sense of balance of the user in the manner described.

VR should not be confused with Augmented Reality (AR), in which the user can still view his surroundings through a pair of glasses. Only additional graphical content is then shown in the user's field of vision. In the case of such graphical content being a selection menu, then US 2007/0052672 A1 discloses an AR system in which a menu element can be selected from a selection menu using sensor technology on a frame of the pair of glasses. As an alternative to the sensor technology on the frame, a smartphone, for instance, can also be connected in order to be able to use the operator controls of same to control the selection.

US 2010/0156836 A1 discloses an AR system which is used to display selection menus to a user on a real panel. The panel is touch-sensitive so that the user can touch the panel to select a menu option from the selection menus.

US 2011/0213664 A1 discloses a pair of glasses for an AR system, with which glasses a user can use an operating apparatus, which can be worn on the user's wrist, to make a selection from a selection menu shown in the user's field of vision. Alternatively, the user can raise his hand into his field of vision and hold his finger on a menu element of the shown selection element in order to make a selection thereby.

The AR systems known from the related art have the advantage that the user can constantly orientate himself spatially with respect to the real surroundings, which the user can see in the background in addition to the selection menus, with the result that if a position of the user's hand, for instance, is detected imprecisely, the user's sense of balance is not impaired during the menu selection.

### SUMMARY

One possible object is to enable a user to control a selection element in a virtual space without visual contact with the surrounding area in a manner that only negligibly impairs the user's sense of orientation.

The inventor proposes an operating apparatus, which comprises in the described manner for operating an electrical device, for instance a VR simulator, a display device to be worn on the head, which is designed to screen the eyes of the user from a surrounding area in an opaque manner and to depict a virtual space stereoscopically in front of the eyes. The display device is preferably in the form of a pair of VR glasses. A control device is designed to display at least one spatial element in the virtual space by the display device. For example, each spatial element may be one virtual object in the space or one menu option in a selection menu. A graphical user interface hence shows a virtual reality (VR).

In order for the user now to be able to select a spatial element, a touchpad is provided in the operating apparatus and connected to the control device so that the control device receives the position signals from points of contact of an object on the touchpad. The control device is designed to position in the virtual space a selection symbol at a spatial position according to the contact point of the object, and thereby to select a spatial element from the at least one spatial element depicted. Selection in this case means that, for example, a cursor is positioned in front of the spatial element from the user's viewpoint, or the spatial element is accentuated visually, for instance by changing the color or the light intensity. A selected spatial element is thereby identified for activating an associated function of the electronic device.

The operating apparatus has the advantage that using the touchpad enables highly precise operation, allowing the menu structure to be kept smaller than in an approach that finds the position of a hand freely in space, with the result that the menu structure does not conceal a large part of the field of vision. The user is hence able to orientate himself/herself visually in the virtual space, which is still easily visible, when a selection menu is shown. The user can achieve orientation with respect to the selection menu separately from his visual perception by the haptic sensory perception on the touchpad, with the result that the user's sense of balance is not impaired.

A touchpad is a touch-sensitive surface, which means that points of contact can only be detected in a two-dimensional plane. In order to assist the user here in setting the three-dimensional spatial position of a selection symbol, in a development of the operating apparatus, all the spatial positions of the selection symbol that are possible and can be set using the touchpad are confined to a predetermined two-dimensional area in the virtual space. A plane, for instance a plane that extends horizontally or vertically in the virtual space, or even a curved surface can be provided here as the area. The at least one selectable spatial element is then arranged on this area, within which the user can move the selection symbol using the touchpad. This results in the advantage that the user does not have to move the selection symbol along a third dimension in the three-dimensional space in order to position the selection symbol on one of the spatial elements. If the spatial elements are depicted as objects in the virtual space, the two-dimensional area can thus also be simply the surface of the virtual space that the user sees. The selection symbol can then be deflected like a shadow or light spot over this surface using the touchpad.

According to another development, the at least one spatial element depicts in each case a menu option in a selection menu. The user can then hence use the touchpad to operate a selection menu. The operating apparatus is here preferably designed to display the selection symbol and/or the at least one spatial element only while the touchpad is being touched. Simply by placing, for example, a finger or an object on the touchpad, the user can then activate the display of the at least one spatial element and/or of the selection symbol, so can show a selection menu for instance as required.

After selecting a spatial element by suitable positioning of the selection symbol, the user must still be able to confirm the selection in order to activate thereby that function associated with the selectable spatial element. The function is in this case a function of the electronic device to be operated by the operating apparatus. According to an advantageous development, the touchpad here comprises a special sensor device, specifically a device designed to have at least two levels, i.e. it produces a sensor signal, which produces a touch signal when the touchpad is being touched, thereby signaling the current contact point, and when the touchpad is being pressed (more firmly), produces a pressure signal, which signals that the user is now pressing on the touchpad with a pressure that is greater compared with touching. In response to the pressure signal, that function is selected that is associated with the spatial element currently selected by the selection symbol. The advantage resulting from providing the two-level or also multi-level or even continuous pressure detection on the touchpad is that the user, after selecting a spatial element, does not need to change hand position, which would be a problem since the opaque VR glasses prevent the user from seeing his hand when it is not depicted in the virtual space.

It is also advantageous if the operating apparatus comprises a chair for the user and the touchpad is integrated into an armrest of the chair. The feel of the chair gives the user an additional spatial orientation in real space while looking into the virtual space. In particular, the user can thereby align an object or finger more precisely on the touchpad.

On the other hand, according to another development, the touchpad is designed to be portable and able to be moved freely by the user. This results in the advantage that the user can use his entire body to perform movements in space, which can then likewise be translated into a greater freedom of movement in the virtual space. In this case, the user can advantageously carry the touchpad with him/her.

With regard to the design of the selection symbol, it has proved particularly advantageous if it comprises a set of crosshairs through which the user can see the spatial element to be selected. In other words, in order to select a spatial element, the user must bring the crosshairs between the user's virtual focus of vision in the virtual space and the spatial element to be selected, i.e. effectively target said crosshairs on this spatial element. The resultant advantage is that it is possible to dispense with positioning the selection symbol along the third dimension, namely the line of sight. In combination with the two-dimensional maneuvering of the selection symbol using the flat touchpad, it is thereby possible to implement a very precise selection capability for individual spatial elements in the virtual space at particularly low cost in terms of sensor technology.

The operating apparatus is preferably part of a presentation arrangement for depicting a representation of a product, for example a motor vehicle, in the virtual space. The inventor accordingly also proposes the presentation arrangement, which comprises a processor device as the electronic device, which processor device is likewise meant to be operated by the operating apparatus and is designed for three-dimensional rendering, i.e. depiction, of the representation of the product that a customer is meant to be able to view in the virtual space. The presentation arrangement comprises at least one operating apparatus according to an embodiment, which operating apparatus is designed to depict the representation of the product in the virtual space. By the touchpad, the user can advantageously control the processor device, i.e. the rendering process thereof, and thereby get the depicted representation of the product displayed as the user requires in order to gain an impression of the product.

Operating the operating apparatus results in a method, namely a control device depicts by a display device worn on the head of a user at least one spatial element, for instance one or more menu options, in a stereoscopically depicted virtual space, and the control device positions a selection symbol on a spatial position in the virtual space according to a contact point of an object, for instance a wand or finger, on the touchpad described, and thereby identifies a spatial element as selected from the at least one spatial element.

The inventor also proposes developments of the proposed method, which comprises features as already described in connection with the developments of the proposed operating apparatus. The corresponding developments of the method are therefore not described here.

### BRIEF DESCRIPTION OF THE DRAWINGS

These and other objects and advantages of the present invention will become more apparent and more readily appreciated from the following description of the preferred embodiments, taken in conjunction with the accompanying drawing of which:

The FIGURE shows a schematic diagram of a potential embodiment of the proposed presentation arrangement containing an embodiment of the proposed operating apparatus.

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

The exemplary embodiment described below is a preferred embodiment. In the exemplary embodiment, however, the components of the embodiment that are described each constitute individual features to be considered independently of one another, which features also each develop the proposals independently of one another and hence shall also be deemed part of the proposals either individually or in a combination other than that shown. Furthermore, additional features to those already described can also be added to the described embodiment.

The FIGURE shows a presentation arrangement 10, which comprises a pair of smart glasses 14 worn by a user 12, a processor device 16 connected thereto, and a touchpad 18 connected to the processor device 16. The processor device 16 comprises a rendering module 16′ and a control module 16″, both of which can be provided, for example, as program modules and/or electronic circuits in the processor device 16.

The touchpad 18 can be integrated in an armrest 20 of a chair, which is not shown in greater detail and in which the user 12 can sit during use of the presentation arrangement 10. The user 12 can lay an arm 22 on the armrest 20 and operate the touchpad 18 using a finger 24 for example. This touchpad can detect, for example, a current contact point or a current contact position P of a fingertip of the finger 24, and also, for example, a contact pressure D of the fingertip of the finger 24 on the touchpad. The touchpad 18 transmits suitable signals corresponding to the contact position P and the contact pressure D to the processor device 16, where they can be received by the control module 16″. The control module 16″ can control the rendering module 16′ according to the contact position P and/or the contact pressure D. The rendering module 16′ can calculate on the basis of control commands from the control module 16″ graphics data G, which controls the smart glasses 14. The graphics data G describes a virtual space 26.

The smart glasses 14 screen the eyes of the user 12 from seeing through to the user's surroundings, and a stereoscopic image of the virtual space 26 is displayed to the user 12 in accordance with the graphics data G. For the purpose of illustration, the figure also shows the perspective of the user 12. An operating menu 30 can be shown in the virtual space 26 in front of a background 28 when the touchpad is being touched 18. Touching is identified by the control module 16″ from the position signal for the contact position P and/or from the pressure signal for the contact pressure D. The selection menu 30 can comprise a plurality of menu options 32, for example, each of which is here provided by way of example with a menu text M1, M2, M3, M4 for the sake of clarity.

To select a menu point 32, the user changes the contact position P on the touchpad 18 by, for instance, performing with the fingertip a stroking action 34 on the touchpad. In the example shown in the figure, a selection symbol 36 can be positioned in the virtual space 26 according to the current contact position P, which selection symbol can perform movements 34′ in the virtual space 26 that correspond to the stroking action 34. The selection symbol 36 can comprise a set of crosshairs 38 and/or a shadowing or colored accentuation 40 of the currently selected menu option 32.

It can be provided that the selection symbol 36 can be moved solely in a predetermined area, for instance the surface of the selection menu 30, using the touchpad 18. In the example shown in the figure, the user 12 moves by a stroking action 34 the selection symbol 36 on the menu option 32 having the menu title M3. The user can now initiate the function of the processor device 16 that is associated with the menu option having the menu title M3 by pressing with the finger 24 on the touchpad 18, i.e. increasing the contact pressure D, which can be identified by the control module 16″ and interpreted as a confirmation of the selection. It is now possible, for example, to show in the virtual space 26 a representation of a product, for instance a motor vehicle that the user 12 wishes to find out about.

Thus by the touchpad 18, the user 12 has the capability of direct interaction in the virtual space 26 even without being able to see his hand 24 or having it depicted in the virtual space 26. The user 12 here uses the touchpad 18 as an operator control. It can be provided that the processor device 16 depicts the selection menu 30 and/or the selection symbol 36 in the virtual space 26 only while the user 12 is touching the touchpad 18. It can then be provided that the selection menu 30 is shown in a defined area and distance in the virtual space 26, and a selection symbol 36, in the example a set of crosshairs 38 and a highlighting 40, is depicted in the center of the field of vision. The user can now use an object with very precise, definable movements on the touchpad 18 to scroll over the correct selection point, and then use pressure on the touchpad 18, which is being touched anyway, to confirm the selection. The touchpad 18 can be built into a seat rest or chair rest 20 or positioned in a separate operator control that has a practical portable design.

The advantage of this method is that operation of the selection menu 30 is based very closely on user behavior learned from the PC, and that highly precise operation is possible because touch sensors can be used, and the fingers of the hand 24 do not need to be detected in space, for instance by a camera, in order to be able to control a positioning of the selection symbol 36. The highly precise operation means it is possible to keep the menu structure containing the selection menu 30 relatively small in relation to the background 28 of the virtual space 26, so that a large part of the field of vision is not concealed. Preferably, the selection menu 30, i.e. in general the shown spatial elements selectable by the touchpad, is in total so small that a maximum of 50 percent of the field of vision of the user is covered in the virtual space 26. The user is then still able to view the background 28, which as a result of movements moves relative to the user's head positions. The user is in this case not irritated by the cursor, i.e. the selection symbol 36, controlled on the basis of the stroking actions 34.

Overall, the example shows how it is possible to interact in a VR environment using a touchpad.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. An operating apparatus for operating an electronic device, the operating apparatus comprising:
a display device to be worn on a head of a user, to screen eyes of the user from a surrounding area in an opaque manner and to depict a virtual space stereoscopically in front of the eyes;
a touchpad to sense a contact point at which an object contacts the touchpad; and
a control device connected to the display device and the touchpad:
to display by the display device at least one spatial element in the virtual space;
to display a selection symbol and to position the selection symbol at a spatial position in the virtual space according to the contact point of the object on the touchpad; and
to select a selected spatial element, the selected spatial element being the at least one spatial element proximate to the selection symbol.

2. The operating apparatus according to claim 1, wherein
the at least one spatial element is displayed in a predetermined two-dimensional area portion of a total potential display area, and
spatial positions to display the selection symbol are restricted to the predetermined two-dimensional area portion at which the at least one spatial element is displayed.

3. The operating apparatus according to claim 1, wherein each spatial element of the at least one spatial element is in a menu option of a selection menu.

4. The operating apparatus according to claim 1, wherein the selection symbol is displayed only while the touchpad is being touched.

5. The operating apparatus according to claim 1, wherein the selection symbol and the at least one spatial element are displayed only while the touchpad is being touched.

6. The operating apparatus according to claim 1, wherein
the touchpad comprises a sensor device that has at least two sense levels,
when the touchpad is being touched with a first pressure, a touch signal is produced, causing the selection symbol to be displayed,
when the touchpad is being touched with a second pressure greater than the first pressure, a pressure signal that differs from the touch signal is produced, and
each spatial element is associated with a respective function of the electronic device,
upon receiving the pressure signal, the control device activates the respective function associated with the selected spatial element.

7. The operating apparatus according to claim 1, wherein the operating apparatus comprises a chair for the user and the touchpad is integrated into an armrest of the chair.

8. The operating apparatus according to claim 1, wherein the touchpad is portable and able to be moved freely by the user.

9. The operating apparatus according to claim 1, wherein the selection symbol comprises a set of crosshairs through which the user can see the selected spatial element.

10. The operating apparatus according to claim 1, wherein
a plurality of spatial elements are displayed in the virtual space,
each spatial element relates to a menu option of a selection menu, and
the selected spatial element is accentuated visually on the display device.

11. The operating apparatus according to claim 10, wherein
each spatial element is displayed together with menu text describing the respective menu option.

12. The operating apparatus, according to claim 1, wherein
the at least one spatial element is displayed in a menu display area of the display device, and
the menu display area of the display device occupies 50% or less of a total field of vision display area of the display device.

13. The operating apparatus according to claim 1, wherein the control device moves the selection symbol as the contact point of the object on the touchpad changes.

14. A presentation apparatus for depicting a representation of a product, comprising:
an electronic device; and
an operating apparatus for operating the electronic device, the operating apparatus comprising:
a display device to be worn on a head of a user, to screen eyes of the user from a surrounding area in an opaque manner and to depict a virtual space stereoscopically in front of the eyes;
a touchpad to sense a contact point at which an object contacts the touchpad; and
a control device connected to the display device and the touchpad:
to display by the display device at least one spatial element in the virtual space;
to display a selection symbol and position the selection symbol at a spatial position in the virtual space according to the contact point of the object on the touchpad; and
to select a selected spatial element, the selected spatial element being
the at least one spatial element proximate to the selection symbol, wherein
the electronic device is a processor device that prepares a three-dimensional rendering of the product in the virtual space.

15. The presentation arrangement according to claim 14, wherein
the product is a motor vehicle,
a plurality of spatial elements are displayed in the virtual space, each spatial item relating to a menu option of a selection menu,
each menu option relates to an option for the motor vehicle, and
selection of the selected spatial element causes the display device to display the respective option for the motor vehicle.

16. A method for operating an operating apparatus for operating an electronic device, comprising:
presenting a display on a display device worn on a head of a user, the display being presented in a stereoscopically depicted virtual space;
displaying at least one spatial element in the virtual space of the display device;
using a touchpad to sense a contact point at which an object contacts the touchpad;
displaying a selection symbol at a spatial position in the virtual space according to the contact point of the object on the touchpad; and
selecting a selected spatial element, the selected spatial element being the at least one spatial element proximate to the selection symbol.

17. The method according to claim 16, wherein
the display is presented on the display device such that eyes of the user are screened from a surrounding area in an opaque manner.
